(19) United States
(12) Patent Application Publication
(10) Pub. No.: US 2026/0236155 A1
(43) Pub. Date: Aug. 13, 2026

(54) METHOD AND APPARATUS FOR PROVIDING REQUIRED FUNCTION, AND DEVICE AND MEDIUM

(71) Applicant: GOERTEK INC., Weifang, Shandong (CN)

(72) Inventors: Mingming YANG, Weifang, Shandong (CN); Baocheng LI, Weifang, Shandong (CN); Xudong QIU, Weifang, Shandong (CN); Qinghe YANG, Weifang, Shandong (CN); Yufeng LI, Weifang, Shandong (CN); Gaojian SHI, Weifang, Shandong (CN); Yongfu CHEN, Weifang, Shandong (CN); Yueqing CHEN, Weifang, Shandong (CN); Jiaming LI, Weifang, Shandong (CN); Tongquan ZHANG, Weifang, Shandong (CN); Guoxin LI, Weifang, Shandong (CN); Xuxu LUO, Weifang, Shandong (CN); Jiujian SUN, Weifang, Shandong (CN); Zhipeng ZHU, Weifang, Shandong (CN); Xiaoyu CHI, Weifang, Shandong (CN)

(21) Appl. No.: 19/151,803

(22) PCT Filed: Jun. 18, 2024
(86) PCT No.: PCT/CN2024/099729

§ 371 Date: Jul. 29, 2025

(30) Foreign Application Priority Data
Aug. 16, 2023 (CN) 202311033709.7

(51) Int. Cl. G06F 3/04847; G06F 3/01; G06T 5/50

(52) U.S. Cl. CPC G06F 3/04847; G06F 3/013; G06T 5/50; G06T 2207/20221

(57) ABSTRACT

The present disclosure relates to head-mounting. Discloses are a method and apparatus for providing a required function, and a device and a medium. The method includes: receiving display requirement information; receiving a plurality of first sub-programs executable to perform a first required function of a head-mounted device when the display requirement information is a preset display requirement, wherein the first required function at least includes a multi-device fusion function and a function for controlling a streaming device of the head-mounted device; generating first sub-function modules corresponding to the first required function according to the first sub-programs; receiving a first input for selecting a target first sub-function module from among the first sub-function modules; and providing an interface of the target first sub-function module and interface description information in response to the first input. Therefore, a head-mounted device may provide a user with a service that meets the requirement.

The present application claims the priority to a Chinese Patent Application No. 202311033709.7, entitled “METHOD AND APPARATUS FOR PROVIDING REQUIRED FUNCTION, AND DEVICE AND MEDIUM” filed with the Chinese Patent Office on Aug. 16, 2023, the entire contents of which are incorporated into the present application by reference.

### TECHNICAL FIELD

The present disclosure relates to the technical field of head-mounting, and particularly to a method for providing a required function, an apparatus for providing a required function, a head-mounted device and a computer-readable storage medium.

### BACKGROUND

With the development of science, technology and economy, a head-mounted display device (such as AR device and VR device) has been used more and more widely.

The head-mounted display device is realized in two forms, including a split head-mounted device and an integrated head-mounted device. However, compared with the integrated head-mounted device, the split head-mounted device is excellent in power consumption, endurance, weight and heat dissipation, and therefore, the split head-mounted device has become a trend of market and technical development. For the split head-mounted device, it is usually adapted with a PUCK device as a processing unit.

Currently, the head-mounted devices provided to a user can implement fixed functions. Therefore, the head-mounted devices cannot provide differentiated services for the user.

### SUMMARY

An object of the present disclosure is to provide a new technical solution for providing a required function.

According to a first aspect of the present disclosure, a method for providing a required function is provided, which is applied to a head-mounted device, wherein the method includes:

receiving display requirement information;

receiving a plurality of first sub-programs executable to perform a first required function of the head-mounted device when the display requirement information is a preset display requirement, wherein the first required function at least includes a multi-device fusion function and a function for controlling a streaming device of the head-mounted device;

generating first sub-function modules corresponding to the first required function according to the first sub-programs;

receiving a first input for selecting a target first sub-function module from among the first sub-function modules; and

providing an interface of the target first sub-function module and interface description information in response to the first input.

Optionally, the method further includes:

receiving a second input based on interface description information corresponding to a target interface; and

executing a target first sub-function module corresponding to the target interface in response to the second input.

Optionally, the target interface is an interface of a target first sub-function module corresponding to the multi-device fusion function, and the executing the target first sub-function module corresponding to the target interface in response to the second input includes:

acquiring an image of at least one streaming device and an image of a control device of the head-mounted device according to the interface description information corresponding to the target interface; and

fusing the image of the at least one streaming device and the image of the control device to obtain a fused image; and

displaying the fused image.

Optionally, the method further includes:

in an eye-tracking interaction mode, acquiring a gaze state of a wearer of the head-mounted device and performing an operation matching with the gaze state; and

in a dual interaction mode of virtual identifier and eye-tracking, acquiring a gaze position of the head-mounted device and a projection position of a virtual identifier in the fused image and performing an operation matching with the gaze position and the projection position.

Optionally, the method further includes:

receiving at least one second sub-program executable to perform a second required function of the head-mounted device, wherein the second required function is a newly added required function;

generating a second sub-function module corresponding to the second required function according to the second sub-program; and

when receiving a third input for selecting the second sub-function module, providing an interface of the second sub-function module and interface description information in response to the third input.

Optionally, the method further includes:

receiving a plurality of third sub-programs executable to perform a third required function of a control device of the head-mounted device;

generating third sub-function modules corresponding to the third required function according to the third sub-programs; and

when the control device is communicatively connected to the head-mounted device, sending an interface of the third sub-function modules and interface description information to the control device.

Optionally, the method further includes:

receiving a plurality of fourth sub-programs executable to perform a fourth required function of the streaming device;

generating fourth sub-function modules corresponding to the fourth required function according to the fourth sub-programs; and

when the head-mounted device is communicatively connected to the streaming device, sending an interface of the fourth sub-function modules and interface description information to the streaming device.

Optionally, the providing the interface of the target first sub-function module and the interface description information in response to the first input includes:

providing the interface of the target first sub-function module and the interface description information in a form of a software development kit in response to the first input.

According to a second aspect of the present disclosure, an apparatus for providing a required function is provided, which is applied to a head-mounted device, wherein the apparatus includes:

a first receiving module configured to receive display requirement information;

a second receiving module configured to receive a plurality of first sub-programs executable to perform a first required function of the head-mounted device when the display requirement information is a preset display requirement, wherein the first required function include at least a multi-device fusion function and a function for controlling a streaming device of the head-mounted device;

a generating module configured to generate first sub-function modules corresponding to the first required function according to the first sub-programs;

a third receiving module configured to receive a first input for selecting a target first sub-function module from among the first sub-function modules; and

a providing module configured to provide an interface of the target first sub-function module and interface description information in response to the first input.

According to a third aspect of the present disclosure, a head-mounted device is provided, the head-mounted device includes the apparatus for providing the required function according to the second aspect; or

the head-mounted device includes a memory configured to store a computer instruction and a processor configured to execute the computer instruction on the memory, to perform steps of the method for providing the required function according to any one of the first aspect.

According to a fourth aspect of the present disclosure, a computer-readable storage medium is provided, on which a computer program is stored, wherein the computer program, when executed by a processor, implements steps of the method for providing the required function according to any one of the first aspect.

In an embodiment of the present disclosure, a method for providing a required function is provided, which is applied to a head-mounted device, and by three steps of receiving display requirement information; receiving a plurality of first sub-programs executable to perform a first required function of the head-mounted device when the display requirement information is a preset display requirement, wherein the first required function at least includes a multi-device fusion function and a function for controlling a streaming device of the head-mounted device; and generating first sub-function modules corresponding to the first required function according to the first sub-programs, the method can implement modularization of the first required function of the head-mounted device to obtain the first sub-function module corresponding to each first required function. Further, based on two steps of receiving a first input for selecting a target first sub-function module from among the first sub-function modules; and providing an interface of the target first sub-function module and interface description information in response to the first input, the method can implement the specification of the target first required function that meets the requirement and the customization of the first required function in the head-mounted device. On this basis, the head-mounted device may provide the user with a service that meets the requirement. That is, the head-mounted device may provide a personalized service for the user.

Other features and advantages of the present disclosure will become apparent from the following detailed description of exemplary embodiments of the present disclosure with reference to the drawings.

### BRIEF DESCRIPTION OF DRAWINGS

To more clearly illustrate the technical solution in the embodiments of the disclosure or the related art, the drawings required to be used in the embodiments or the related art will be briefly described in the following. Obviously, the drawings described in the following are only some embodiments of the disclosure, and for those skilled in the art, other drawings may be obtained according to the structures shown in these drawings without any creative effort.

FIG. 1 is a first block diagram of a hardware configuration of a head-mounted device for implementing a method for providing a required function according to an embodiment of the present disclosure;

FIG. 2 is a schematic flowchart of a method for providing a required function according to an embodiment of the present disclosure;

FIG. 3 is a schematic diagram of a functional architecture of a control device, a head-mounted device and a streaming device according to an embodiment of the present disclosure;

FIG. 4 is a schematic structural diagram of an apparatus for providing a required function according to an embodiment of the present disclosure; and

FIG. 5 is a second block diagram of a hardware configuration of a head-mounted device for implementing a method for providing a required function according to an embodiment of the present disclosure.

Implementations of objects, functional features and advantages of the present disclosure will be further described with reference to the drawings and embodiments.

### DETAILED DESCRIPTIONS

The following clearly and completely describes the technical solutions in the embodiments of the present disclosure with reference to the drawings in the embodiments of the present disclosure. Obviously, the described embodiments are only part embodiments but not all embodiments of the present disclosure. All other embodiments obtained by those skill in the art based on the embodiments of the present disclosure without creative efforts shall fall within the protection scope of the present disclosure.

It should be noted that, if a directional indication (such as up, down, left, right, front, back . . . ) is involved in the embodiments of the present disclosure, the directional indication is only used to explain the relative positional relationship, motion condition, etc. between the components in a specific posture (as shown in the drawings), and if the specific posture changes, the directional indication also changes accordingly.

In addition, if there are descriptions related to “first”, “second” etc. in the embodiments of the present disclosure, the descriptions of the “first”, “second” etc. are only used for descriptive purposes, and cannot be understood as indicating or implying their relative importance or implicitly indicating the number of indicated technical features. Thus, features defining the “first” and “second” may explicitly or implicitly include at least one of the features. In addition, the meaning of “and/or” appearing throughout the full text includes three parallel solutions, taking “A and/or B” as an example, it includes solution A, or solution B, or solutions that both A and B are satisfied. In addition, the technical solutions of the various embodiments may be combined with each other, but must be on the basis that the combination of the technical solutions can be implemented by those skill in the art, and when the combination of the technical solutions is contradictory or cannot be implemented, it should be considered that the combination of the technical solutions does not exist, and is not within the protection scope of the present disclosure.

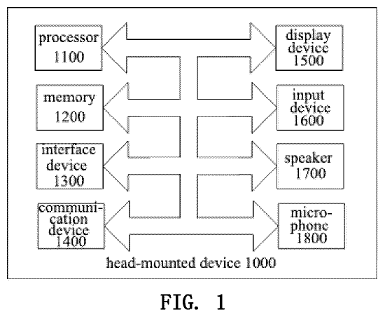

FIG. 1 is a first block diagram of a hardware configuration of a head-mounted device for implementing a method for providing a required function according to an embodiment of the present disclosure.

The head-mounted device is a split head-mounted device. The split head-mounted device may be a split head-mounted device such as AR, MR, VR, or XR. The head-mounted device has an adaptive control device, and the control device is specifically a data processing unit of the head-mounted device. The control device is a device having an operating system. The operating system may be an Android operating system, an iOS operating system or another possible operating system, which is not specifically limited in the embodiment of the present disclosure.

The head-mounted device 1000 may include a processor 1100, a memory 1200, an interface device 1300, a communication device 1400, a display device 1500, an input device 1600, a speaker 1700, a microphone 1800 etc. The processor 1100 may be a central processing unit CPU, a microprocessor MCU, or the like. For example, the memory 1200 includes a Read Only Memory (ROM), a Random Access Memory (RAM), a non-volatile memory such as a hard disk, etc. For example, the interface device 1300 includes a USB interface, a headphone interface, etc. For example, the communication device 1400 is capable of wired or wireless communication. For example, the display device 1500 is a liquid crystal display screen, a touch display screen, or the like. For example, the input device 1600 may include a touch screen, a keyboard, etc. The user may input/output voice information by the speaker 1700 and the microphone 1800.

Although a plurality of devices are shown for the head-mounted device 1000 in FIG. 1, the present disclosure may only relate to some of the devices, for example, the head-mounted device 1000 only relates to the memory 1200 and the processor 1100.

In an embodiment of the present disclosure, the memory 1200 of the head-mounted device 1000 is used to store an instruction, and the instruction is used to control the processor 1100 to perform a method for providing a required function provided in the embodiment of the present disclosure.

In the above description, those skilled in the art may design instructions according to the solutions disclosed in the present disclosure. How the instructions control the operation of the processor is well known in the art and will not be described in detail herein.

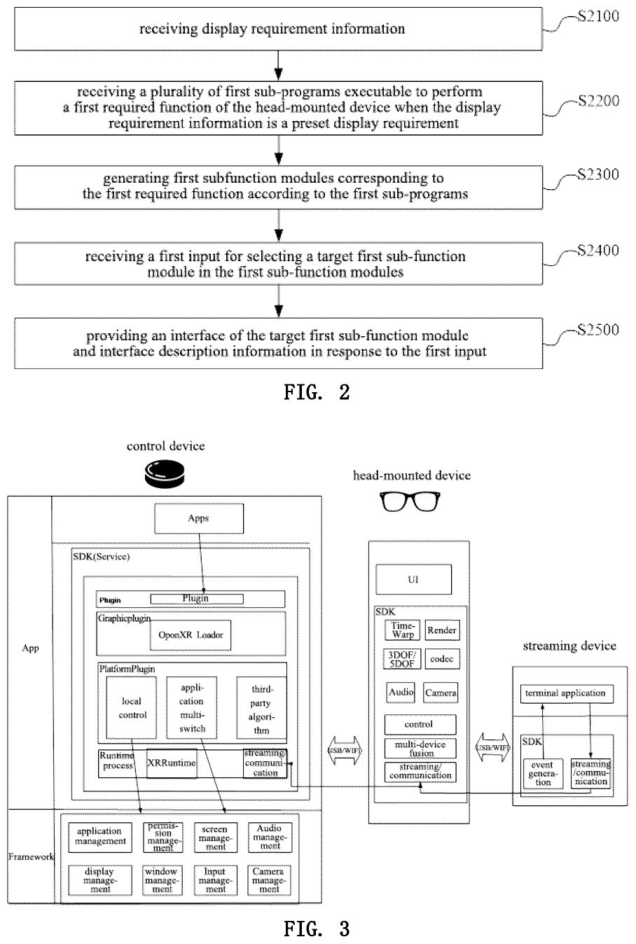

An embodiment of the present disclosure provides a method for providing a required function, which is applied to a head-mounted device, and as shown in FIG. 2, the method includes the following steps S2100-S2500:

S2100: receiving display requirement information.

In the embodiment of the present disclosure, the display requirement information is information indicating that the display requirement is a low-latency display requirement, or information indicating that the display requirement is a non-low-latency display requirement.

S2200: receiving a plurality of first sub-programs executable to perform a first required function of the control device when the display requirement information is a preset display requirement.

The first required function at least includes device fusion and controlling of a streaming device of the head-mounted device.

It should be noted that the method for providing the required function in the embodiment of the present disclosure is applied to a streaming scenario. The scenario includes a control device, a head-mounted device and a streaming device, and the head-mounted device and the streaming device are respectively communicatively connected to the control device. The communication connection manner may be a Wi-Fi manner or a USB manner. For example, the streaming device may be a mobile phone, a PAD, a PC, etc.

In the embodiment of the present disclosure, the preset display requirement may be specifically a low-latency display requirement.

The first required function is a default required function of the head-mounted device in an initial state. One first required function corresponds to one first sub-program, that is, there is a one-to-one correspondence between the first required functions and the first sub-programs.

In an embodiment of the present disclosure, for example, the first required function may include a streaming/communication function, a multi-device fusion function, a function of controlling a streaming device of the head-mounted device, a function of obtaining Camera data on the head-mounted device side, a function of obtaining Audio data on the head-mounted device side, a function of obtaining 3Dof/6Dof data on the head-mounted device side to perform image cropping and/or perform space anchoring, a codec function, a Time Warp function, a function of rendering on the screen, etc.

Here, the streaming/communication function includes a streaming function and a communication function, wherein the streaming function specifically refers to a function of receiving a display image of the streaming device and a function of displaying the display image of the streaming device, and the communication function specifically refers to a function of transmitting a control command between the streaming device and the head-mounted device, Audio data, Camera data, etc.

The multi-device fusion function specifically refers to a function of implementing fusion of the display image of the control device and the display image of the streaming device.

For any one of the above first required function, a developer inputs a program executable to perform (that is, implementing) the first required function to the head-mounted device. In the embodiment of the present disclosure, the above program is denoted as a first sub-program. Based on this, the head-mounted device receives a plurality of first sub-programs executable to perform first required functions of the head-mounted device.

When the display requirement information is a preset display requirement, that is, a low-latency display requirement, multi-device fusion and controlling of a streaming device of the head-mounted device are implemented by the head-mounted device, to meet the low-latency display requirement. Based on this, when the display requirement information is the preset display requirement, a plurality of first sub-programs executable to perform the first required functions of the head-mounted device including at least the multi-device fusion function and the function for controlling the streaming device of the head-mounted device are received.

Correspondingly, when the display requirement information is not the preset display requirement information, an operation of receiving a plurality of first sub-programs executable to perform the first required functions of the head-mounted device is not received or responded to.

S2300: generating first sub-function modules corresponding to the first required function according to the first sub-programs.

In the embodiment of the present disclosure, for any one first sub-program, the head-mounted device performs packaging protection on the first sub-program to obtain a corresponding first sub-function module. And, the first sub-function module has an interface for calling the first sub-program therein and interface description information of the interface. The interface description information is used to describe how to use the interface.

Based on the above S2200 and S2300, modularization of the first required function of the head-mounted device can be implemented. In this way, a customization basis may be provided for subsequently customizing the first required function meeting the requirement for the user.

S2400: receiving a first input for selecting a target first sub-function module in the first sub-function modules.

In the embodiment of the present disclosure, a first sub-function module that meets a requirement of the user among the first sub-function modules is denoted as a target first sub-function module. The first input is an input for selecting the target first sub-function module from the first sub-function modules.

There may be at least one target first sub-function. It should be noted that the number of target first sub-functions is not limited in the embodiment of the present disclosure.

The specifying for the target first required function that meets the requirement may be implemented by the above S2400.

S2500: providing an interface of the target first sub-function module and interface description information in response to the first input.

In the embodiment of the present disclosure, the first sub-function module selected based on the first input is used as the target first sub-function module. After the target first sub-function module is determined, the interface of the target first sub-function module and the interface description information are provided. In this way, how to invoke the corresponding interface may be determined based on the description information of the interface. And, after the interface is invoked based on the description information of the interface, the head-mounted device may implement the first required function corresponding to the target first sub-function module which corresponds to the interface.

In an example, when the target first sub-function module is the first sub-function module with the multi-device fusion function and the function for controlling the streaming device of the head-mounted device, based on the above S2500, the head-mounted device may implement the multi-device fusion function and the function for controlling the streaming device of the head-mounted device.

By the above S2500, the customization of the first required function in the head-mounted device can be implemented. In this way, the head-mounted device may provide the user with a service that meets the requirement. That is, the head-mounted device may provide a personalized service for the user.

In an embodiment of the present disclosure, for example, the above S2500 may be implemented according to the following S2510:

S2510: providing the interface of the target first sub-function module and the interface information in a form of a software development kit in response to the first input.

In the embodiment of the present disclosure, the target first sub-function interface and the interface information are presented to the user by the manner of the software development kit (SDK). As the SDK is a common manner for the user, and the interface information provided in the manner of the software development kit further includes information such as an interface operation example, the user can conveniently use the head-mounted device by the S2510.

In an embodiment of the present disclosure, a method for providing a required function is provided, which is applied to a head-mounted device, and by three steps of receiving display requirement information; receiving a plurality of first sub-programs executable to perform a first required function of the head-mounted device when the display requirement information is a preset display requirement, wherein the first required function at least includes a multi-device fusion function and a function for controlling a streaming device of the head-mounted device; and generating first sub-function modules corresponding to the first required function according to the first sub-programs, the method can implement modularization of the first required function of the head-mounted device to obtain the first sub-function module corresponding to each first required function. Further, based on two steps of receiving a first input for selecting a target first sub-function module from among the first sub-function modules; and providing an interface of the target first sub-function module and interface description information in response to the first input, the method can implement the specification of the target first required function that meets the requirement and the customization of the first required function in the head-mounted device. On this basis, the head-mounted device may provide the user with a service that meets the requirement. That is, the head-mounted device may provide a personalized service for the user.

In an embodiment of the present disclosure, the method for providing the required function provided in the embodiment of the present disclosure further includes the following S2610 and S2611:

S2610: receiving a second input based on interface description information corresponding to a target interface.

In the embodiment of the present disclosure, the target interface is an interface that meets an invocation requirement of the user. The user performs an input of an operation of invoking the target interface according to the interface description information of the target interface. Based on this, the control device receives the second input.

S2611: executing a target first sub-function module corresponding to the target interface in response to the second input.

In the embodiment of the present disclosure, when the second input is received, the head-mounted device executes the first sub-program corresponding to the target first sub-function module executed by the second input. In this case, the head-mounted device may implement the required function corresponding to the target first sub-function module executed by the second input.

Based on the embodiments illustrated in the above S2610 and the S2611, when the target interface is an interface of the target first sub-function module corresponding to the multi-device fusion function, the S2611 is specifically implemented by the following S2611-1 to S2611-3:

S2611-1: acquiring an image of at least one streaming device and an image of a control device of the head-mounted device according to the interface description information corresponding to the target interface.

SS2611-2: fusing the image of the at least one streaming device and the image of the control device to obtain a fused image.

S2611-3: displaying the fused image.

In the embodiment of the present disclosure, an image of at least one streaming device and an image of a control device are acquired in an acquisition manner specified in the interface description information corresponding to the target interface. And, the image of the at least one streaming device and the image of the control device are spliced to obtain the fused image. Based on this, image fusion is implemented. Further, the head-mounted device displays the fused image.

In the embodiment of the present disclosure, when the user invokes the interface of the target first sub-function module corresponding to the multi-device fusion function, the head-mounted device may implement the multi-device fusion function by the above S2611-1 to S2611-3.

Based on the embodiments illustrated in the above S2611-1 to S2611-3, the method for providing the required function provided in the embodiment of the present disclosure further includes the following S2611-4 and S2611-5:

S2611-4: in an eye-tracking interaction mode, acquiring a gaze state of a wearer of the head-mounted device and performing an operation matching the gaze state.

S2611-5: in a dual interaction mode of virtual identifier and eye-tracking, acquiring a gaze position of the wearer of the head-mounted device and a projection position of a virtual identifier in the fused image and performing an operation matching with the gaze position and the projection position.

In the embodiment of the present disclosure, the interaction on the fused image has two interaction modes. The two interaction modes are an eye-tracking interaction mode, and a dual interaction mode of virtual identifier and eye-tracking.

In the embodiment of the present disclosure, the eye-tracking interaction mode refers to a manner that the eye of the wearer of the head-mounted device interacts with the fused image.

The dual interaction mode of virtual identifier and eye-tracking refers to a manner that both the virtual identifier transmitted by the control device and the eye of the wearer of the head-mounted device interact with the fused image. In an embodiment of the present disclosure, the virtual identifier is used to describe a path between the control device and the interaction position when the wearer executes the control device by hand to point towards the interaction position on the fused image. In an example, the virtual identifier may be a straight line, a ray or a curve, which is not limited in the embodiment of the present disclosure.

In an embodiment of the present disclosure, the above two interaction modes may be selected by the user according to the requirement himself, or may be automatically selected according to an application type of an application currently operated on the control device, which is not limited in the embodiment of the present disclosure.

In an embodiment of the present disclosure, in an eye-tracking mode, a gaze position of the wearer on the fused image and a gaze time period corresponding to the gaze position may be determined by an eye tracking algorithm. In the embodiment of the present disclosure, the gaze position and the gaze time period are denoted as gaze states.

In addition, in the eye-tracking mode, the control device performs different operations for different gaze states. For example, when the gaze state indicates that the gaze position does not change, and the gaze time period corresponding to the gaze position reaches a preset duration, it is determined that the wearer is in a state of gazing the gaze position, and at this time, an operation matching with the state of gazing the gaze position is performed. The operation matching with the state of gazing the gaze position may be specified in advance. In an example, the operation matching with the state of gazing the gaze position may be a confirmation operation.

For another example, when the gaze state indicates that the gaze position is unchanged, but the gaze time period corresponding to the gaze position is two discontinuous short time periods, it is determined that the wearer is in a state of blinking twice, and at this time, an operation matching with the state of blinking twice on the gaze position is performed. Similarly, the operation matching with the state of blinking on the gaze position may be specified in advance. In an example, the operation matching with the state of blinking on the gaze position may be a copy operation.

In an embodiment of the present disclosure, in a dual interaction mode of virtual identifier and eye-tracking, a gaze position of the wearer on the fused image may be determined by an eye tracking algorithm. In addition, a projection position of the virtual identifier in the fused image is obtained by a conventional manner of determining the projection position of the virtual identifier on the fused image. Based on the above content, the operation of performing the operation matching with the gaze position and the projection position in the above S2611-5 is specifically:

When a difference between the position of the virtual identifier on the fused image and the gaze position of the wearer is less than a preset threshold, it is determined that the position of the virtual identifier on the fused image coincides with the gaze position of the wearer, and at this time, an operation corresponding to the gaze position and/or the virtual identifier at the projection position is performed. For example, when a button corresponding to the gaze position and/or the virtual identifier at the projection position is a “confirm” button, a confirmation operation corresponding to the button is performed.

Correspondingly, when the difference between the position of the virtual identifier on the fused image and the gaze position of the wearer is less than the preset threshold, it is determined that the position of the virtual identifier on the fused image does not coincide with the gaze position of the wearer, and no operation is performed.

For the dual interaction mode of virtual identifier and eye-tracking, the accuracy requirement for eye tracking is low, which can reduce the power consumption of the control device. Correspondingly, in the eye-tracking interaction mode, high precision is required for eye tracking.

In an embodiment of the present disclosure, the method for providing the required function provided in the embodiment of the present disclosure further includes the following S2710-S2712:

S2710. receiving at least one second sub-program executable to perform a second required function of the head-mounted device.

The second required function is a newly added required function.

In the embodiment of the present disclosure, when the developer adds a new required function, namely, the second required function, based on the default required function, namely, the first required function, the developer inputs a program executable to perform the second required function to the head-mounted device. In the embodiment of the present disclosure, the above program is denoted as the second sub-program. Based on this, the control device receives at least one second sub-program executable to perform the second required function of the head-mounted device.

S2711: generating a second sub-function module corresponding to the second required function according to the second sub-program.

In the embodiment of the present disclosure, specific implementation of the S2711 is the same as specific implementation of the S2300, and details are not described herein again.

S2712: when receiving a third input for selecting the second sub-function module, providing an interface of the second sub-function module and interface description information in response to the third input.

In an embodiment of the present disclosure, specific implementation of the above S2712 may be: when a third input for selecting the second sub-function module is received, providing an interface of the second sub-function module and interface description information in response to the third input in a form of a software development kit.

In the embodiment of the present disclosure, the third input is an input of selecting the second sub-function module by the user. When the third input is received, it indicates that the user expects that the head-mounted device can implement the second required function corresponding to the second sub-function module. In this case, the head-mounted device provides the interface of the second sub-function module and the interface description information, for the user to invoke the second sub-function module.

In the embodiment of the present disclosure, the above S2610-S2612 can realize the addition of the required function of the head-mounted device, and allow the user to execute the newly added required function.

In an embodiment of the present disclosure, the method for providing the required function provided in the embodiment of the present disclosure further includes the following S2810-S2812:

S2810. receiving a plurality of third sub-programs executable to perform a third required function of a control device of the head mounted device.

S2811: generating third sub-function modules corresponding to the third required function according to the third sub-programs.

S2812: when the control device is communicatively connected to the head-mounted device, sending an interface of the third sub-function modules and interface description information to the control device.

It should be noted that specific implementations of the S2810 and the S2811 are the same as specific implementations of the S2200 and the S2300, and details are not described herein again.

In an embodiment of the present disclosure, the S2812 may be specifically implemented as follows: when the control device is in communication connection with the head-mounted device, sending an interface of the third sub-function module and interface description information provided in a form of a software development kit to the control device.

In the embodiment of the present disclosure, the head-mounted device is compatible with the control device and is complementary to the control device. Therefore, the control device is required to implement a required function adapted to the head-mounted device. In an embodiment of the present disclosure, the function of the control device adapted to the requirement of the head-mounted device is denoted as a third required function.

Besides, the head-mounted device generates the third sub-function module of the third required function, and sends the interface of the third sub-function module and the interface description information to the control device based on the communication connection between the control device and the head-mounted device. In this way, when the head-mounted device is compatible with the control device, there is no need to improve on the control device side.

In an embodiment of the present disclosure, for example, the third required function may respectively include: a streaming/communication function, a plug-in function, an application multi-switch function, a function of receiving a control instruction of the head-mounted device, a function of supporting controlling a local application of the control device in a plurality of interaction manners such as ray, gesture and voice, a function of supporting mouse interaction and keyboard interaction of each screen after application multi-switch, a function of supporting screen-based volume control, a function of supporting implementing gesture recognition and plane detection and the like using Camera data of the head-mounted device by a third-party algorithm.

Here, the application multi-switch function specifically refers to: starting multiple applications (local applications and/or applications on the streaming device) at the same time, so that each application runs on a different screen of the head-mounted device, these applications are all in the foreground, and subsequent applications, windows, etc. started by the applications must run on the same screen as the applications, and this function needs to be customized by a Framework layer.

Corresponding to the above embodiment, in an embodiment of the present disclosure, the method for providing the required function provided in the embodiment of the present disclosure further includes the following S2910-S2912:

S2910. receiving a plurality of fourth sub-programs executable to perform a fourth required function of the streaming device.

S2911: generating fourth sub-function modules corresponding to the fourth required function according to the fourth sub-programs.

S2912: when the head-mounted device is communicatively connected to the streaming device, sending an interface of the fourth sub-function modules and interface description information to the streaming device.

It should be noted that specific implementations of the above S2910 and the S2911 are the same as specific implementations of the S2200 and the above S2300, and details are not described herein again.

In an embodiment of the present disclosure, the above S2912 may be specifically implemented as follows: when the head-mounted device is communicatively connected to the streaming device, sending an interface of the fourth sub-function module and interface description information that are provided in a form of a software development kit to the streaming device.

In an embodiment of the present disclosure, the streaming device is compatible with the head-mounted device and is complementary to the head-mounted device. Therefore, the streaming device is required to implement a required function adapted to the head-mounted device. In an embodiment of the present disclosure, the function of the streaming device adapted to the requirement of the head-mounted device is denoted as a fourth required function.

Besides, the head-mounted device generates the fourth sub-function module of the fourth required function, and sends the interface of the fourth sub-function module and the interface description information to the streaming device based on the communication connection between the head-mounted device and the streaming device. In this way, when the streaming device is compatible with the head-mounted device, there is no need to improve on the streaming device side.

In an embodiment of the present disclosure, for example, the fourth required function may respectively include: a streaming/communication function, a function of receiving a control instruction on a control device side, and a function of converting the control instruction into a coordinate time and reporting the coordinate time to an application of the streaming device.

With reference to the above content, functional architectures of the control device, the head-mounted device and the streaming device in the embodiment of the present disclosure are shown in FIG. 3.

FIG. 3 shows an example in which the control device supports an OpenXR standard and an operating system thereof is an Android operating system. Based on this, the software development kit SDK of the control device is divided into a Plugin layer, a Graphic Plugin layer, a Platform Plugin layer and a Runtime process layer. In addition, the SDK serves as a service layer of the APP layer. In addition, a local control function to the control device and an application multi-switch function are essentially implemented based on a framework layer. Besides, the framework layer includes application management, permission management, screen management, Audio management, display management, window management, Input management and Camera management when the local control function to the control device and the application multi-switch function are implemented based on the framework layer.

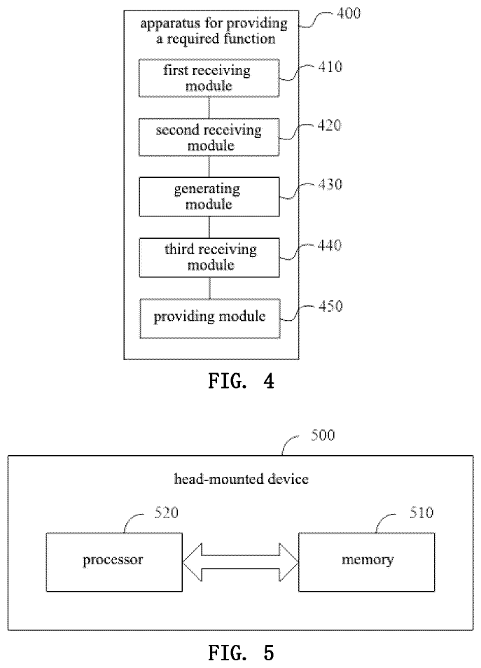

An embodiment of the present disclosure further provides an apparatus for providing a required function 400, which is applied to a control device of a head-mounted device, and as shown in FIG. 4, the apparatus includes:

a first receiving module 410 configured to receive display requirement information;

a second receiving module 420 configured to receive a plurality of first sub-programs executable to perform a first required function of the head-mounted device when the display requirement information is a preset display requirement, wherein the first required function at least includes a multi-device fusion function and a function for controlling a streaming device of the head-mounted device;

a generating module 430 configured to generate first sub-function modules corresponding to the first required function according to the first sub-programs;

a third receiving module 440 configured to receive a first input for selecting a target first sub-function module from among the first sub-function modules; and

a providing module 450 configured to provide an interface of the target first sub-function module and interface description information in response to the first input.

Based on the apparatus for providing the required function provided in the embodiment of the present disclosure, the head-mounted device may provide a user with a service that meets a requirement. That is, the head-mounted device may provide personalized services for the user.

In an embodiment of the present disclosure, the apparatus for providing the required function 400 provided in the embodiment of the present disclosure further includes:

a fourth receiving module configured to receive a second input based on interface description information corresponding to a target interface; and

a running module configured to run a target first sub-function module corresponding to the target interface in response to the second input.

In an embodiment of the present disclosure, the target interface is an interface of a target first sub-function module corresponding to a multi-device fusion function, and the running module is specifically configured to:

acquire an image of at least one streaming device and an image of a control device of the head-mounted device according to the interface description information corresponding to the target interface;

fuse the image of the at least one streaming device and the image of the control device to obtain a fused image; and

display the fused image.

In an embodiment of the present disclosure, the running module is further configured to:

in an eye-tracking interaction mode, acquire a gaze state of a wearer of the head-mounted device and perform an operation matching with the gaze state; and

in a dual interaction mode of virtual identifier and eye-tracking, acquire a gaze position of the head-mounted device and a projection position of a virtual identifier in the fused image and perform an operation matching with the gaze position and the projection position.

In an embodiment of the present disclosure, the second receiving module 420 is further configured to receive at least one second sub-program executable to perform a second required function of the head-mounted device, wherein the second required function is a newly added required function;

the generation module 430 is further configured to generate a second sub-function module corresponding to the second required function according to the second sub-program; and

the providing module 450 is further configured to, when receiving a third input for selecting the second sub-function module, provide an interface of the second sub-function module and interface description information in response to the third input.

In an embodiment of the present disclosure, the second receiving module 420 is further configured to receive a plurality of third sub-programs executable to perform a third required function of the control device of the head-mounted device;

the generating module 430 is further configured to generate third sub-function modules corresponding to the third required function according to the third sub-programs;

In the embodiment, the apparatus for providing the required function 400 further includes:

a sending module configured to, when the control device is communicatively connected to the head-mounted device, send an interface of the third sub-function modules and interface description information to the control device.

In an embodiment of the present disclosure, the second receiving module 420 is further configured to receive a plurality of fourth sub-programs executable to perform a fourth required function of the streaming device;

the generating module 430 is further configured to generate fourth sub-function modules corresponding to the fourth required function according to the fourth sub-programs;

the sending module is further configured to send an interface of the fourth sub-functions module and interface description information to the streaming device when the head-mounted device is communicatively connected to the streaming device.

In an embodiment of the present disclosure, the providing module 450 is specifically configured to provide the interface of the target first sub-function module and the interface description information in a form of a software development kit in response to the first input.

An embodiment of the present disclosure further provides a head-mounted device 500, and the head-mounted device 500 includes the apparatus for providing a required function 400 provided by any one of the above apparatus embodiments.

Alternatively, as shown in FIG. 5, the head-mounted device 500 includes a memory 510 configured to store a computer instruction and a processor 520 configured to execute the computer instruction on the memory 510, to perform steps of the method for providing the required function according to any one of the above method embodiments.

An embodiment of the present disclosure further provides a computer-readable storage medium on which a computer program is stored, wherein the computer program implements the method for providing the required function according to any one of the above method embodiments when executed by a processor.

The present disclosure may be a system, a method, and/or a computer program product. The computer program product may include a computer readable storage medium on which a computer readable program instruction for causing a processor to implement aspects of the present disclosure is loaded.

The computer readable storage medium may be a tangible device that can retain and store instructions for use by an instruction execution device. For example, the computer readable storage medium may be, but is not limited to, an electronic storage device, a magnetic storage device, an optical storage device, an electromagnetic storage device, a semiconductor storage device or any suitable combination of the above. More specific examples (that is, a non-exhaustive list) of the computer readable storage medium includes the following: a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as a punch-card or a raised structure in a groove having instructions recorded thereon, and any suitable combination of the above. The computer readable storage medium used herein is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from the computer readable storage medium or to an external computer or external storage device via a network, for example, Internet, a local area network, a wide area network and/or a wireless network. The network may include copper transmission cables, optical fiber transmission, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or source code or object code written in any combination of one or more programming languages, the programming languages include an object oriented programming language such as Smalltalk, C++ or the like, and conventional procedural programming languages, such as “C” programming language or similar programming languages. The computer readable program instructions may execute entirely on the user's computer, execute partly on the user's computer, execute as a stand-alone software package, execute partly on the user's computer and partly on a remote computer, or execute entirely on the remote computer or server. In a case related to the remote computer, the remote computer may be connected to the user's computer through any type of network, including a local area network (LAN) or a wide area network (WAN), or may be connected to an external computer (for example, through the Internet using an Internet Service Provider). In some embodiments, the electronic circuit may be personalized by using state information of the computer readable program instructions, for example, the electronic circuit may be programmable logic circuit, field-programmable gate arrays (FPGA) or programmable logic arrays (PLA), and the electronic circuit may execute the computer readable program instructions to perform aspects of the present disclosure.

Aspects of the present disclosure are described herein with reference to flowchart and/or block diagrams of methods, apparatus (systems) and computer program products according to embodiments of the invention. It will be understood that each block of the flowchart and/or block diagrams and combinations of blocks in the flowchart and/or block diagrams may be implemented by the computer readable program instructions.

These computer readable program instructions may be provided to a processor of a general-purpose computer, special purpose computer or other programmable data processing device to produce a machine, such that the instructions, when executed by the processor of the computer or other programmable data processing device, create the device for implementing the functions/acts specified in one or more block of the flowchart and/or block diagram. These computer readable program instructions may also be stored in the computer readable storage medium, these instructions can direct a computer, a programmable data processing device and/or other devices to function in a particular manner, such that the computer readable storage medium having instructions stored therein includes an article of manufacture including instructions which implement aspects of the function/act specified in one or more block of the flowchart and/or block diagram.

The computer readable program instructions may also be loaded onto a computer, other programmable data processing device or other device to cause a series of operational steps to be performed on the computer, other programmable device or other device to produce a computer implemented process, such that the instructions executed on the computer, other programmable device or other device implement the functions/acts specified in one or more block of the flowchart and/or block diagram.

The flowchart and block diagrams in the drawing illustrate the architecture, functionality and operation which are possible implemented of systems, methods and computer program products according to various embodiments of the present disclosure. In this regard, each block in the flowchart or the block diagrams may represent a module, a segment, or a portion of instructions, which includes one or more executable instructions for implementing the specified logical function. In some alternative implementations, the functions noted in the block may occur out of the order noted in the drawing. For example, two succession blocks may, in fact, be executed substantially concurrently, or may sometimes be executed in the reverse order, depending upon the functionality involved. It will also be noted that each block of the block diagrams and/or flowchart and combinations of blocks in the block diagrams and/or flowchart can be implemented by special purpose hardware-based systems that perform the specified functions or acts, or combinations of special purpose hardware and computer instructions. It is well known to those skilled in the art that implementation by hardware, implementation by software, and implementation by a combination of software and hardware are all equivalent. It should be noted that, in this specification, the terms “comprise”, “include” or any other variant thereof are intended to cover non-exclusive inclusion, so that a process, method, article, or system that includes a series of elements includes not only those elements, but also other elements that are not explicitly listed, or elements inherent to such a process, method, article, or system. An element proceeded by “comprise a . . . ” does not, without more constraints, exclude the existence of additional identical elements in the process, method, article, or system that includes the element.

The sequence numbers of the embodiments of the present disclosure are merely for description, and do not represent the preference of the embodiments.

Through the description of the above implementations, a person skilled in the art may clearly understand that the methods in the above embodiments may be implemented by using software and a necessary general hardware platform, or may be implemented by using hardware, in many cases, the former is a better implementation. Based on such understanding, the technical solution of the present disclosure essentially or the part contributing to the prior art may be embodied in the form of a software product, and the computer software product is stored in a storage medium (such as a ROM/RAM, a magnetic disk, or an optical disc) as above, and includes several instructions to enable a terminal device (which may be a mobile phone, a computer, a server, a television or a network device, etc.) to execute the method of each embodiment of the present disclosure.

The above descriptions are only preferred embodiments of the present disclosure, and are not intended to limit the patent scope of the present disclosure, and any equivalent structural transformation made by using the content of the description and the drawings of the present disclosure or directly/indirectly applied to other related technical fields under the inventive concept of the present disclosure are included in the patent protection scope of the present disclosure.

1. A method for providing a required function, which is applied to a head-mounted device, the method comprising:
receiving display requirement information;
receiving a plurality of first sub-programs executable to perform a first required function of the head-mounted device when the display requirement information is a preset display requirement, wherein the first required function at least comprise a multi-device fusion function and a function for controlling a streaming device of the head-mounted device;
generating first sub-function modules corresponding to the first required function according to the first sub-programs;
receiving a first input for selecting a target first sub-function module in the first sub-function modules; and
providing an interface of the target first sub-function module and interface description information in response to the first input.

2. The method according to claim 1, further comprising:
receiving a second input based on interface description information corresponding to a target interface; and
executing a target first sub-function module corresponding to the target interface in response to the second input.

3. The method according to claim 2, wherein the target interface is an interface of a target first sub-function module corresponding to the multi-device fusion function, and the executing the target first sub-function module corresponding to the target interface in response to the second input comprises:
acquiring an image of at least one streaming device and an image of a control device of the head-mounted device according to the interface description information corresponding to the target interface;
fusing the image of the at least one streaming device and the image of the control device to obtain a fused image; and
displaying the fused image.

4. The method according to claim 3, further comprising:
in an eye-tracking interaction mode, acquiring a gaze state of a wearer of the head-mounted device and performing an operation matching with the gaze state; and
in a dual interaction mode of virtual identifier and eye-tracking, acquiring a gaze position of the head-mounted device and a projection position of a virtual identifier in the fused image and performing an operation matching with the gaze position and the projection position.

5. The method according to claim 1, further comprising:
receiving at least one second sub-program executable to perform a second required function of the head-mounted device, wherein the second required function is a newly added required function;
generating a second sub-function module corresponding to the second required function according to the second sub-program; and
when receiving a third input for selecting the second sub-function module, providing an interface of the second sub-function module and interface description information in response to the third input.

6. The method according to claim 1, further comprising:
receiving a plurality of third sub-programs executable to perform a third required function of a control device of the head-mounted device;
generating third sub-function modules corresponding to the third required function according to the third sub-programs; and
when the control device is communicatively connected to the head-mounted device, sending an interface of the third sub-function modules and interface description information to the control device.

7. The method according to claim 1, further comprising:
receiving a plurality of fourth sub-programs executable to perform a fourth required function of the streaming device;
generating fourth sub-function modules corresponding to the fourth required function according to the fourth sub-programs; and
when the head-mounted device is communicatively connected to the streaming device, sending an interface of the fourth sub-function modules and interface description information to the streaming device.

8. The method according to claim 1, wherein the providing the interface of the target first sub-function module and the interface description information in response to the first input comprises:
providing the interface of the target first sub-function module and the interface description information in a form of a software development kit in response to the first input.

9. (canceled)

10. A head-mounted device, wherein
the head-mounted device comprises a memory configured to store a computer instruction and a processor configured to execute the computer instruction on the memory, to perform steps of the method for providing the required function according to claim 1.

11. A computer-readable storage medium, on which a computer program is stored, wherein the computer program, when executed by a processor, implements steps of the method for providing the required function according to claim 1.
